(19) United States
(12) Patent Application Publication
(10) Pub. No.: US 2003/0142922 A1
(43) Pub. Date: Jul. 31, 2003

(54) Passive alignment of fiber optic array

(76) Inventors: Joseph L. Dallas, Maple Glen, PA (US); Angelique X. Irvin, Radnor, PA (US); Robert W. Irvin, Radnor, PA (US); Ralph S. Jameson, Orefield, PA (US); William A. Mamakos, Laurel, MD (US)

Correspondence Address: CANTOR COLBURN, LLP, 55 GRIFFIN ROAD SOUTH, BLOOMFIELD, CT, 06002

(21) Appl. No.: 10/058,896

(22) Filed: Jan. 28, 2002

(51) Int. Cl. G02B 6/36

(52) U.S. Cl. 385/83; 385/85; 385/139

(57) ABSTRACT

A method for optically joining an optical fiber array holder with an opponent member includes: disposing the plurality of optical fibers extending from the end face in a fiber array holder; polishing an end face of each of the plurality of optical fibers disposed in the fiber array block; removing the fiber array block from the plurality of optical fibers; and placing the plurality of optical fibers in corresponding guides formed in a waveguide substrate, the polished end faces of each of the plurality of optical fibers extending to an opponent member.

### BACKGROUND

The present invention relates to alignment of a fiber optic array, and more specifically to passive alignment of a fiber optic array with a waveguide device.

A standard technique for aligning a single optical fiber to an optical waveguide on a planar waveguide device is to form a V-shaped groove in the waveguide substrate that extends from the end of the waveguide to the edge of the substrate. An optical fiber is then placed in the V-shaped groove, and translated toward the waveguide until the core of the fiber contacts the waveguide, making an optical connection between the optical fiber and waveguide. A significant advantage of the above-described single fiber alignment is that it is done passively.

Many efforts have been made to incorporate passive alignment schemes between a fiber array and an array of corresponding waveguides on a planar waveguide device. One such effort is described in U.S. Pat. No. 5,482,585 to Ota et al., entitled “Process for Optically Joining an Optical Fiber Array to an Opponent Member”. U.S. Pat. No. 5,482,585 describes a method in which an optical fiber array is formed by fixing optical fibers between a V-grooved base plate and a fixing base plate with the optical fibers fitted in respective V-grooves formed on a surface of the V-grooved base plate. The optical fibers of the optical fiber array are optically joined to the opponent member by using, as a joining reference surface, either one of a first surface of the fixing base plate at which the optical fibers are fixed and a second surface of the fixing base plate opposite to the surface.

Another effort is described in U.S. Pat. No. 5,339,876 to Kakii et al., entitled “Grooved Optical Fiber Connection Incorporating Elastic Guide Pin Pressing Members.” U.S. Pat. No. 5,339,876 describes an optical connector for connecting optical fibers comprising a guide-groove substrate having grooves for positioning optical fibers and guide pins; an upper plate having groove portions each for covering the guide pins positioned in the guide grooves of the guide-groove substrate; elastic guide-pin pressing members each provided in the groove portions of the upper plate above portions where the guide pin grooves are in contact with the guide pins.

While such efforts provide some means of passive alignment between the array and the waveguide device, there remains a need for passive alignment of an optical fiber array with corresponding waveguides on a planar waveguide device.

### BRIEF SUMMARY

In a first aspect of the present invention, there is provided a method for optically joining an optical fiber array holder with an opponent member. The method includes: disposing the plurality of optical fibers extending from the end face in a fiber array holder; polishing an end face of each of the plurality of optical fibers disposed in the fiber array block; removing the fiber array block from the plurality of optical fibers; and placing the plurality of optical fibers in corresponding guides formed in a waveguide substrate, the polished end faces of each of the plurality of optical fibers extending to an opponent member.

In a second aspect of the present invention, a method for passive alignment of a fiber optic array with a waveguide device comprises: disposing a plurality of optical fibers between a first upper substrate and a first lower substrate; disposing the plurality of optical fibers between a second upper substrate and a second lower substrate; polishing ends of the plurality of fibers flush with a surface formed by the second upper substrate and the second lower substrate; removing the second upper substrate and the second lower substrate; and placing the ends of the plurality of optical fibers in corresponding guides formed in a waveguide substrate.

### BRIEF DESCRIPTION OF THE DRAWINGS

This disclosure will present in detail the following description of preferred embodiments with reference to the exemplary drawings wherein like elements are numbered alike in the several FIGURES:

FIG. 1 is an exploded, perspective view illustrating an array of optical fibers with a fiber array block;

FIG. 2 is a perspective view illustrating an assembled multi-fiber array and fiber block;

FIG. 3 is a perspective view illustrating the multi-fiber array of FIG. 2 with the fiber array block removed;

FIG. 4 is an alternative embodiment of the fiber bock of FIG. 2;

FIG. 5 is another alternative embodiment of the fiber block of FIG. 2; and

FIG. 6 is a perspective view illustrating the multi-fiber array aligned with a waveguide substrate for connection therewith.

### DETAILED DESCRIPTION OF THE PREFERRED EMBODIMENTS

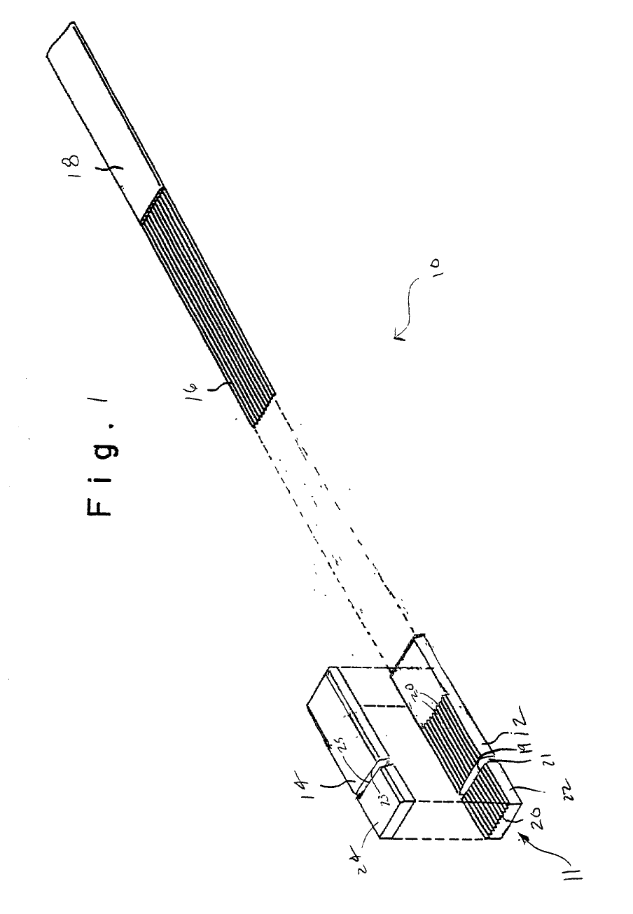

Some embodiments of the invention will now be described in detail in the following Examples. An optical fiber array assembly and a method of producing the same will be described in detail with reference to FIGS. 1 to 6.

Referring to FIG. 1, a multi-fiber array 10 with a fiber array block 11 is shown. The multi-fiber array 10 includes a fiber array holder 13 comprising a lower substrate 12 and an upper substrate 14 which are preferably made of silicon or glass wafers, and a plurality of optical fibers 16 are disposed between the lower substrate 12 and the upper substrate 14. The lower substrate 12 has a plurality of guides formed therein, which are shown by way of example as V-shaped grooves 20. In the embodiment shown in FIG. 1, the upper substrate 14 is a generally flat plate; however, it will be recognized that upper substrate may also include a plurality of V-shaped grooves 20 to cooperate with the V-shaped grooves 20 on the lower substrate 12.

Optical fibers 16 extend at one end from a ribbon part (coated region) 18 of a multi-optical fiber ribbon. Optical fibers 16 may include any known fiber for use in fiber optic systems.

Fiber array block 11 includes a lower substrate 22 and an upper substrate 24. Lower substrate 22 includes a plurality of V-shaped grooves 20 formed therein and aligned with the V-shaped grooves 20 formed in substrate 12 of the fiber array holder 13. In the embodiment shown in FIG. 1, upper substrate 24 is a generally flat plate; however, it will be recognized that upper substrate 24 may also include a plurality of V-shaped grooves 20 to cooperate with the V-shaped grooves 20 on the lower substrate 22.

Multi-fiber array 10 and fiber array block 11 are assembled by abutting an edge 19 of lower substrate 22 with an edge 21 of lower substrate 12 and aligning the V-shaped grooves 20. Each fiber 16 is then disposed in a corresponding groove 20 on both lower substrates 12 and 22. A bonding agent is then applied to: the top of the lower substrate 12, the portion of fibers 16 disposed on lower substrate 12, and, in certain embodiments described herein below, on top of the lower substrate 22 and the portion of fibers 16 disposed on lower substrate 12. Upper substrates 14 and 24 are then applied on top of the bonding agent, fibers 16 and substrates 12 and 22. An edge 23 of upper substrate 14 abuts an edge 25 of upper substrate 24.

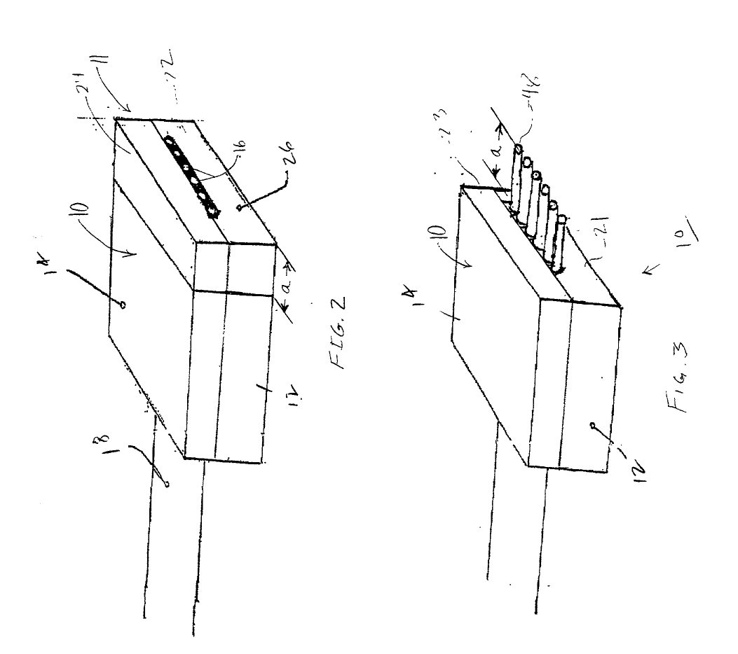

Referring to FIG. 2, an assembled multi-fiber array 10 and fiber array block 11 is shown. An end face 26 of fiber array block 11 provides a surface for collectively polishing fibers 16. Optical fibers 16 are collectively polished, together with the end face 26 of block 40, up to a predetermined position. For example, the predetermined position may correspond to a predetermined dimension “a” measured from the end of fiber array holder 13. Fiber array block 11 is constructed of a material hard enough such that it can be polished so as to achieve optical quality polish on end faces of fibers 16 while limiting damage to the embedded fibers 16 and upper and lower substrates 14, 12 of fiber array holder 13. Consequently, irregular projections of the optical fibers 16 are removed by the polishing so that polished end faces of the optical fibers 16 are flush with the polished end face 26 of block 11.

After the end faces of optical fibers 16 are polished, block 11 is removed from the multi-fiber array 10 as depicted in FIG. 3. A lens 48 is thus formed at the end face of each fiber 16. The end faces of the optical fibers 16 are projected from the end faces 21, 23 of the lower and upper substrates 12, 14 of fiber array holder 13 by the predetermined distance “a”. The predetermined distance “a” may be selected based on the length required for passive alignment with the other optical device, as will be discussed in further detail herein below.

Referring to FIGS. 2, 4, and 5, various examples of the construction of fiber array block 11 and its removal from multi-fiber array 10 can be described. In the embodiment of FIG. 2, fiber array block 11 is constructed of a material having a lower melting temperature than that of the upper and lower substrates 14, 12 of fiber array holder 13 and of the optical fibers 16. In this embodiment, fiber array block 11 is removed from multi-fiber array 10 by heating and melting fiber array block 11. In another embodiment, fiber array block 11 is constructed of a material that may be dissolved (e.g., by application of a chemical) and, thereby, removed from multi-fiber array 10. The fiber array block 11 may be made of a material which is removable from fiber array holder 10 by an etchant. For example, the block 11 may be made of a resin such as epoxy resin. The resin block 11 may be machined or molded to form the V-shaped grooves 20 with high accuracy. The fiber array block 11 can be produced by molding resin in a die, similar to forming a conventional multifiber connector.

In another embodiment, the bonding agent used to secure the upper and lower substrates 24, 22 of block 11 is different from the bonding agent used to secure the upper and lower substrates 14, 12 of the multi-fiber array. In this embodiment, the bonding agent used to secure the upper and lower substrates 24, 22 of block 11 is selected such that its bonding properties can be degraded by the application of heat or chemical, allowing the upper and lower substrates 24, 22 to be separated and removed from multi-fiber array 10.

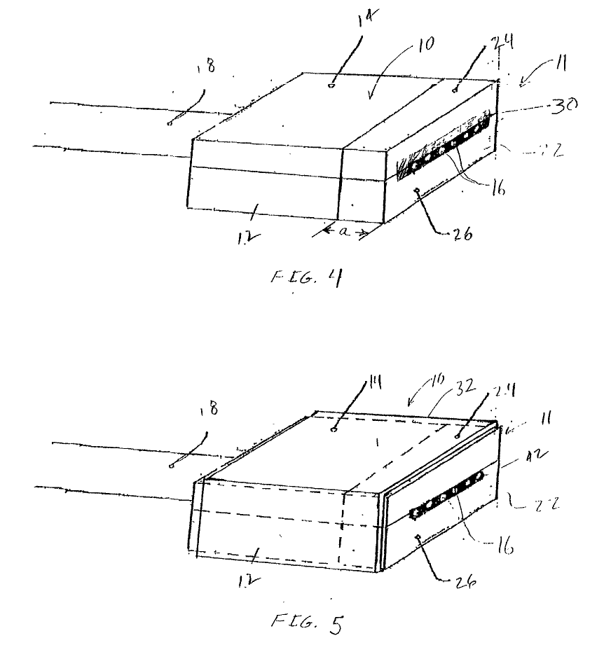

Referring to FIG. 4, an embodiment is shown where upper and lower substrates 24, 22 of block 11 each include an insert material 30, which forms the portions of upper and lower substrates 24, 22 that contact fibers 16. In this embodiment, insert material 30 is selected such that application of heat or chemical to the insert material 30 will cause the insert material 30 to melt or dissolve, thereby allowing upper and lower substrates 24, 22 of block 11 to be removed from multi-fiber array 10.

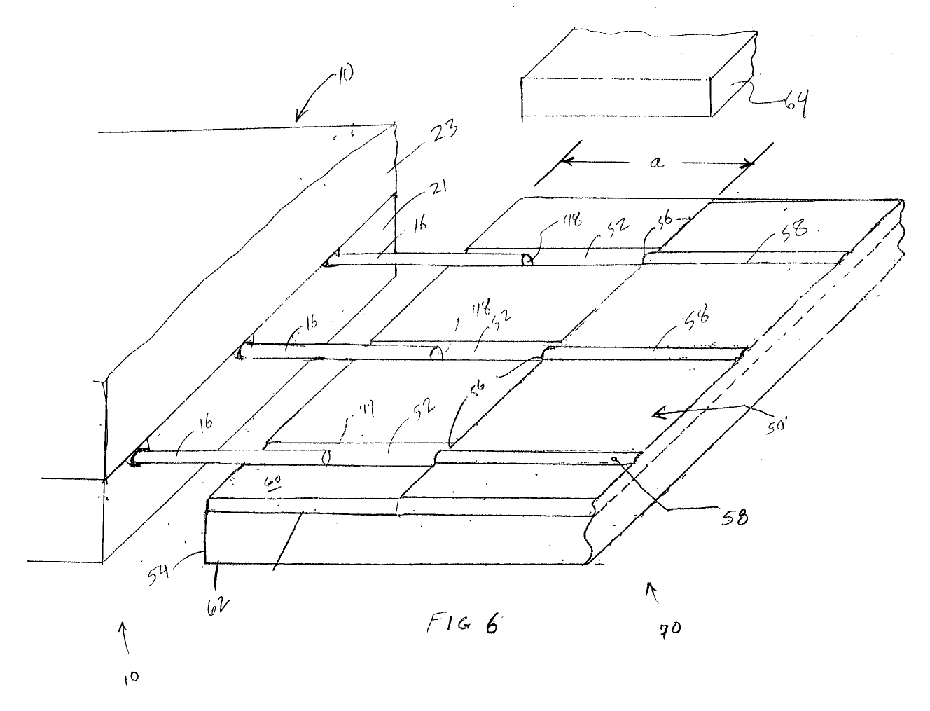

Referring to FIG. 5, an embodiment is shown where upper and lower substrates 24, 22 of block 11 are secured with a mechanical retainer 32. Mechanical retainer 32 is shown as a sleeve surrounding a portion of upper and lower substrates 24, 22 of block 11 and surrounding a portion of upper and lower substrates 14, 12 of fiber array holder 13. During the assembly of multi-fiber array 10 and fiber array block 11 described above, the bonding agent is applied only between the upper and lower substrates 14, 12 of multi fiber array 10 and not between upper and lower substrates 24, 22 of block 11. The mechanical retainer 32 compresses upper and lower substrates 24, 22 of block 11 for retaining fibers 16 therebetween. By extending over both block 11 and fiber array holder 13, mechanical retainer 32 aligns block 11 with fiber array holder 13. After fibers 16 have been polished, mechanical retainer 32 may be removed by sliding the mechanical retainer 32 off of fiber array holder 13 and block 11, allowing block 11 to be removed. It will be recognized that other mechanical retainers (e.g., clips, clamps, etc.) may be used as well.

Referring now to FIG. 6, multi-fiber array 10 is configured for optical connection with an opponent member 70. In the embodiment illustrated, opponent member 70 comprises a planar waveguide substrate 50 having a plurality of guides, which are shown by way of example as V-grooves 52. Each V-groove 52 extending from one edge 54 to an end face 56 of a corresponding waveguide 58. It will be appreciated that end faces 56 may also be an array of optical devices such as laser diodes (LD), photo detectors (PD) or the like. Each V-groove 52 is configured for passive alignment of a corresponding fiber 16 of multi-fiber array 10. V-grooves 52 are preferably equidistant from contiguous V-grooves 52 and are formed with a substantially equivalent depth from a surface 60 using a bottom surface 62 of planar waveguide substrate 50 as a reference point. The length “a” of each V-groove 52 corresponds to the length “a” of each fiber 16 (as shown in FIG. 3) extending from end faces 21, 23 of lower and upper substrates 12, 14 of fiber array holder 13. Each fiber 16 is disposed in a respective V-groove 52 and is slid forward until polished lenses 48 abut end faces 56 of corresponding waveguides 58.

It will be appreciated that the optical fibers 16 are projected from the end faces 21, 23 of the fiber array holder 13 by the predetermined distance “a”, which was established by the fiber block 10 (as shown in FIG. 2). Accordingly, the fiber block 10 can be dimensioned to ensure that the predetermined distance “a” of the fibers 16 matches the length “a” of the v-grooves 52, thereby ensuring that the polished fiber end faces forming lens 48 on the fibers 16 are properly positioned relative to the end faces 56 of the waveguides 58.

After the fibers 16 have been positioned in v-grooves 52, a bonding agent is applied over the v-grooves 52 and the portion of fibers 16 extending within v-grooves 52. An upper waveguide substrate 64 is then applied over the bonding agent, fibers 16, and v-grooves 52 for securing fibers 16 relative to the opponent member 50.

The above described optical fiber array and method for producing the same provides a fiber array holder having optical fibers with optically finished ends for alignment with an opponent member without using costly and time-consuming active alignment means. A planar waveguide substrate is fabricated with V-grooves that allow passive alignment of each optical fiber having an optically finished end in a corresponding V-groove that extends to an end face of the opponent member for optically connecting the optical fiber by contacting the end face of the opponent member. In this manner, the V-grooves are configured in the waveguide substrate to allow the core of each optical fiber to be passively aligned with the end face of the opponent member, such as a waveguide.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for optically joining a plurality of optical fibers extending from an end face of a fiber array holder in a fiber array block to an opponent member, the method comprising:
disposing the plurality of optical fibers extending from the end face in the fiber array holder;
polishing an end face of each of the plurality of optical fibers disposed in said fiber array block;
removing said fiber array block from the plurality of optical fibers; and
placing the plurality of optical fibers in corresponding guides formed in a waveguide substrate, the polished end faces of each of the plurality of optical fibers extending to an opponent member.

2. The method of claim 1, wherein said opponent member includes a plurality of optical waveguides.

3. The method of claim 1, wherein said removing said fiber array block includes dissolving said fiber array block.

4. The method of claim 1, wherein said removing said fiber array block includes melting said fiber array block.

5. The method of claim 1, wherein said fiber array block includes a lower substrate bonded to an upper substrate with a bonding agent, and said removing said fiber array block includes:
melting said bonding agent.

6. The method of claim 1, wherein said fiber array block includes a lower substrate bonded to an upper substrate with a bonding agent, and said removing said fiber array block includes:
dissolving said bonding agent.

7. The method of claim 1, wherein said fiber array block includes a lower and an upper substrate coupled by a mechanical retainer, and said removing said fiber array block includes:
removing said mechanical retainer.

8. The method of claim 1, wherein said fiber array block include a lower and an upper substrate, at least one of said lower and said upper substrate including an insert material proximate said plurality of optical fibers, and wherein said removing said fiber array block includes:
melting said insert material.

9. The method of claim 1, wherein said fiber array block include a lower and an upper substrate, at least one of said lower and said upper substrate including an insert material proximate said plurality of optical fibers, and wherein said removing said fiber array block includes:
dissolving said insert material.

10. The method of claim 1, wherein said fiber array block extends from the end face of the fiber array holder a distance equal to a desired length of the plurality of optical fibers extending from the end face of the fiber array holder.

11. The method of claim 1, wherein said corresponding guides are V-grooves.

12. A method for passive alignment of a fiber optic array with a waveguide device, the method comprising:
disposing a plurality of optical fibers between a first upper substrate and a first lower substrate;
disposing said plurality of optical fibers between a second upper substrate and a second lower substrate;
polishing ends of said plurality of fibers flush with a surface formed by said second upper substrate and said second lower substrate;
removing said second upper substrate and said second lower substrate; and
placing said ends of said plurality of optical fibers in corresponding guides formed in a waveguide substrate.

13. The method of claim 12, wherein said disposing said plurality of optical fibers between said first upper substrate and said first lower substrate includes:
placing said plurality of optical fibers in a corresponding plurality of v-grooves formed in at least one of said first upper substrate and said first lower substrate.

14. The method of claim 13, wherein said disposing said plurality of optical fibers between said second upper substrate and said second lower substrate includes:
placing said plurality of optical fibers in a corresponding plurality of v-grooves formed in at least one of said second upper substrate and said second lower substrate.

15. The method of claim 13, wherein said corresponding guides are V-grooves having the same spacing as said corresponding plurality of v-grooves.

16. The method of claim 12, wherein said removing said second upper substrate and said second lower substrate includes dissolving said second upper substrate and said second lower substrate.

17. The method of claim 12, wherein said removing said second upper substrate and said second lower substrate includes melting said second upper substrate and said second lower substrate.

18. The method of claim 12, further comprising:
applying a first bonding agent between said first upper substrate and said first lower substrate;
applying a second bonding agent between said second upper substrate and said second lower substrate; and
wherein said removing said second upper substrate and said second lower substrate includes melting said second bonding agent.

19. The method of claim 12, further comprising:
applying a first bonding agent between said first upper substrate and said first lower substrate;
applying a second bonding agent between said second upper substrate and said second lower substrate; and
wherein said removing said second upper substrate and said second lower substrate includes dissolving said second bonding agent.

20. The method of claim 12, further comprising:
applying a bonding agent between said first upper substrate and said first lower substrate;
securing said second upper substrate to said second lower substrate with a mechanical retainer; and
wherein said removing said second upper substrate and said second lower substrate includes removing said mechanical retainer.
